(19) United States
(12) Patent Application Publication
(10) Pub. No.: US 2015/0013454 A1
(43) Pub. Date: Jan. 15, 2015

(54) METHOD AND APPARATUS FOR DETECTING INTRUSION INTO VEHICLE

(71) Applicant: ELECTRONICS AND TELECOMMUNICATIONS RESEARCH INSTITUTE, Daejeon-city (KR)

(72) Inventors: Seungjun LEE, Daejeon (KR); Dohyun KIM, Daejeon (KR); Kyongho KIM, Daejeon (KR); Hosang HAM, Daejeon (KR)

(73) Assignee: ELECTRONICS AND TELECOMMUNICATIONS RESEARCH INSTITUTE, Daejeon-city (KR)

(21) Appl. No.: 14/306,909

(22) Filed: Jun. 17, 2014

(30) Foreign Application Priority Data
Jul. 15, 2013 (KR) 10-2013-0082981

(51) Int. Cl. B60R 25/32; G01P 15/00; G01C 3/02

(52) U.S. Cl. CPC B60R 25/32; G01C 3/02; G01P 15/00
USPC 73/509

(57) ABSTRACT

An apparatus and method for detecting intrusion into a vehicle are disclosed. The apparatus includes a first sensor unit, a second sensor unit, and a control unit. The first sensor unit is disposed in the left side-view mirror of a vehicle, and includes an acceleration sensor and a laser sensor. The second sensor unit is disposed in the right side-view mirror of the vehicle, and includes an acceleration sensor and a laser sensor. The control unit detects the sudden movement of the vehicle based on the results of the comparison between the measured and initial values of the acceleration sensor included in each of the first and second sensor units, and detects intrusion into the vehicle using the laser sensor of the first or second sensor unit.

### CROSS REFERENCE TO RELATED APPLICATION

This application claims the benefit of Korean Patent Application No. 10-2013-0082981, filed on Jul. 15, 2013, which is hereby incorporated by reference in its entirety into this application.

### BACKGROUND OF THE INVENTION

1. Technical Field

The present invention relates generally to a method and apparatus for detecting intrusion into a vehicle and, more particularly, to a method and apparatus for detecting intrusion into a vehicle through an open door of a vehicle or a window of a door using wireless sensor nodes disposed within side-view mirrors.

2. Description of the Related Art

As vehicles increase and continue to have higher quality, the stealing of vehicles and the theft of articles within vehicles are increasing. The investigation of Japan's National Policy Agency reveals that the total number of crimes aiming at the stealing of vehicles and the theft of parts and articles within vehicles was 175,065 cases in 2012 and an average of 479 crimes occurred a day. It is estimated that the number of actual crime cases would be much more than this.

As described above, intrusion into a vehicle can be detected using a variety of types of sensors. For example, Korean Patent Application Publication No. 2007-0016016 entitled “An Apparatus and Method of Antitheft in Vehicle” discloses an anti-theft apparatus and method for a vehicle, in which a photo sensor is installed in a room mirror installed within a vehicle and a burglar alarm signal is generated when a change in brightness within the vehicle is detected regardless of brightness outside the vehicle.

In general, acceleration sensors are chiefly used as sensors for detecting intrusion into a vehicle. There is a case where an acceleration sensor used to control a vehicle and an acceleration sensor mounted in a black box are applied to the detection of intrusion into a vehicle.

Such sensors are problematic in that the sensors do not detect intrusion due to their sensitivity, for example, upon a door being opened very slowly because the sensors are used to detect relatively large movement. Furthermore, the erroneous operation of these sensors malfunctions may occur due to sudden movement attributable to a storm and heavy rain in connection with the setting of the sensitivity and threshold of the sensors because the sensors are acceleration sensors for measuring the sudden movement of a vehicle.

In order to perform precise measurement, detection methods using ultrasonic waves and optical sensors within a vehicle are also used. However, these methods are problematic in that high battery consumption attributable to continuous operation occurs, it is difficult to select the location of installation in order to avoid erroneous operation attributable to high sensitivity, and wiring is complicated.

### SUMMARY OF THE INVENTION

Accordingly, the present invention has been made keeping in mind the above problems occurring in the conventional art, and an object of the present invention is to provide a method and apparatus for detecting intrusion through an open door of a vehicle or a window of a door using wireless sensor nodes disposed within side-view mirrors.

In accordance with an aspect of the present invention, there is provided a method of detecting intrusion into a vehicle, including setting the initial value of at least one sensor included in each of first and second sensor units disposed in respective side-view mirrors on both sides of a vehicle; setting the distance between each of the side-view mirrors and a reference point of the vehicle as a reference distance; detecting the sudden movement of the vehicle based on the results of the comparison between the measured and initial values of an acceleration sensor included in each of the first and second sensor units; and measuring the current distance to the reference point using a laser sensor included in the first or second sensor unit when the sudden movement is detected, and detecting intrusion into the vehicle by comparing the current distance with the reference distance.

The method may further include, before detecting the intrusion into the vehicle, setting the laser sensor to a standby state if the sudden movement of the vehicle is not detected.

Detecting the sudden movement of the vehicle may include determining data validity by comparing a first measured value sensed by a first acceleration sensor of the first sensor unit with a threshold corresponding to the first acceleration sensor; determining data validity by comparing a second measured value sensed by a second acceleration sensor of the second sensor unit with a threshold corresponding to the second acceleration sensor; checking whether or not there is a difference between the first and second measured values; and determining that a door including a side-view mirror in which a sensor unit having a higher measured value is disposed has been moved if there is a difference between the first and second measured values.

Determining the data validity may include determining that the first measured value is valid if the first measured value is higher than a threshold corresponding to the first acceleration sensor, and determining that the second measured value is valid if the second measured value is higher than a threshold corresponding to the second acceleration sensor.

Checking whether or not there is the difference may include updating the first measured value with a new threshold if there is no difference between the first and second measured values.

In accordance with another aspect of the present invention, there is provided an apparatus for detecting intrusion into a vehicle, including a first sensor unit disposed in the left side-view mirror of a vehicle, and configured to include an acceleration sensor and a laser sensor; a second sensor unit disposed in a right side-view mirror of the vehicle, and configured to include an acceleration sensor and a laser sensor; and a control unit configured to detect the sudden movement of the vehicle based on the results of the comparison between the measured and initial values of the acceleration sensor included in each of the first and second sensor units, and to detect intrusion into the vehicle using the laser sensor of the first or second sensor unit.

The control unit may be configured to set a distance between each of the side-view mirrors and a reference point of the vehicle as a reference distance before detecting the intrusion into the vehicle; to measure a current distance between each of the side-view mirror and the reference point using the laser sensor when the sudden movement of the vehicle is detected; and to detect intrusion into the vehicle by comparing the measured current distance with the reference distance.

The control unit may be configured to, before detecting intrusion into the vehicle, set the laser sensor to a standby state if the sudden movement of the vehicle is not detected.

The first sensor unit may be configured to determine data validity by comparing a first measured value sensed by a first acceleration sensor of the first sensor unit with a threshold corresponding to the first acceleration sensor, and to determine that the first measured value is valid if the first measured value is higher than the threshold corresponding to the first acceleration sensor.

The second sensor unit may be configured to determine data validity by comparing a second measured value sensed by a second acceleration sensor of the second sensor unit with a threshold corresponding to the second acceleration sensor, and to determine that the second measured value is valid if the second measured value is higher than the threshold corresponding to the second acceleration sensor.

The control unit may be configured to determine that a door including a side-view mirror in which a sensor unit having a higher measured value is disposed has been moved if there is a difference between a first measured value sensed by a first acceleration sensor of the first sensor unit and a second measured value sensed by a second acceleration sensor of the second sensor unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram illustrating the construction of an apparatus for detecting intrusion into a vehicle according to an embodiment of the present invention;

FIG. 2 is a diagram illustrating a sensor unit disposed in a side-view mirror according to an embodiment of the present invention;

FIG. 3 is a reference diagram illustrating a concept in which the sensor unit disposed in the side-view mirror sets a reference distance according to an embodiment of the present invention;

FIG. 4 is a flowchart illustrating a method of detecting intrusion into a vehicle according to an embodiment of the present invention; and

FIG. 5 is a flowchart illustrating a method of detecting intrusion into a vehicle according to another embodiment of the present invention.

### DESCRIPTION OF THE PREFERRED EMBODIMENTS

The present invention is described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

A method and apparatus for detecting intrusion through an open door or a window of a door using wireless sensor nodes within side-view mirrors according to embodiments of the present invention are described in detail below with reference to the accompanying drawings.

That is, the present invention is directed to a method capable of solving the problems of a conventional system for detecting intrusion into a vehicle, and is configured to detect intrusion through an open door and a window of a vehicle using wireless sensor nodes that may be freely installed in side-view mirrors disposed on both sides of a vehicle.

The wireless sensor nodes according to an embodiment of the present invention may determine whether or not a door is opened or whether or not sudden movement is the simply movement of a vehicle body based on the measured values of the nodes because they are symmetrically installed in left and right side-view mirrors. In this case, the left side-view mirror means a side-view mirror on the driver seat side, and the right side-view mirror means a side-view mirror on the front passenger seat side.

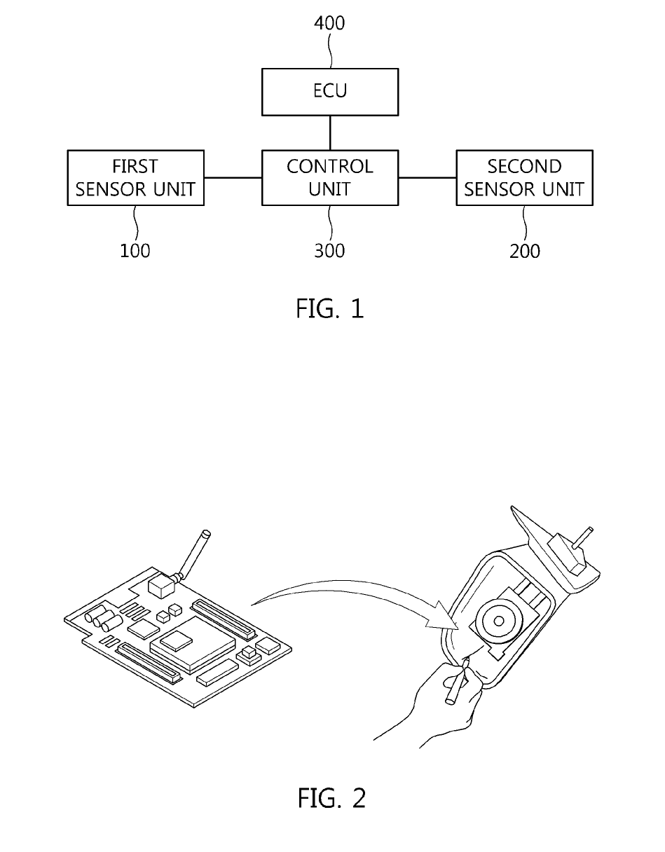

FIG. 1 is a schematic diagram illustrating the construction of an apparatus for detecting intrusion into a vehicle according to an embodiment of the present invention.

Referring to FIG. 1, the apparatus for detecting intrusion into a vehicle includes a first sensor unit 100 disposed in a left side-view mirror, a second sensor unit 200 disposed in a right side-view minor, and a control unit 300 configured to issue commands to an electronic control unit (ECU) 400 within the vehicle based on the sensing results of the first and second sensor units 100 and 200.

Each of the first and second sensor units 100 and 200 corresponds to a wireless sensor node with which at least one sensor is equipped.

The first and second sensor units 100 and 200 determine the data validity of the measured sensing values. In this case, a criterion based on which data validity is determined is determined by comparing a preset threshold with a measured value.

The first sensor unit 100 transfers a first measured value to the control unit 300 if the first measured value is larger than a first threshold.

The second sensor unit 200 transfers a second measured value to the control unit 300 if the second measured value is larger than a second threshold.

When receiving the first measured value from the first sensor unit 100, the control unit 300 receives the second measured value from the other one, that is, the second sensor unit 200, and checks whether there is the difference between the first and second measured values.

If there is the difference between the first and second measured values, the control unit 300 determines that a door in which a sensor unit having a higher measured value is disposed has been opened. In this case, the control unit 300 receives a measured value again from another sensor of the sensor unit having a higher measured value.

If there is no difference between the first and second measured values, the control unit 300 sets the measured values to new thresholds, and updates the first and second thresholds with the new thresholds. The reason why the control unit 300 sets the measured values to the new thresholds if there is no difference between the first and second measured values as described above is that the sudden movement of the vehicle may vary depending on surrounding weather and a parking environment. The settings of the thresholds may be changed when an event in which a value higher than an existing threshold is measured on one of both sides occurs, and the thresholds may be periodically updated.

When intrusion into the vehicle is detected based on data transmitted by the sensor units, the control unit 300 issues a vehicle control command to the ECU 400. For example, the ECU 400 may generate a warning sound or inform a driver of the intrusion into the vehicle via wireless communication in response to the vehicle control command.

If there is a trace of a touch on a door, but intrusion has not been made, the apparatus for detecting intrusion into a vehicle according to this embodiment of the present invention may perform the additional function of determining whether or not the vehicle was scratched or broken and additionally providing an alarm and information.

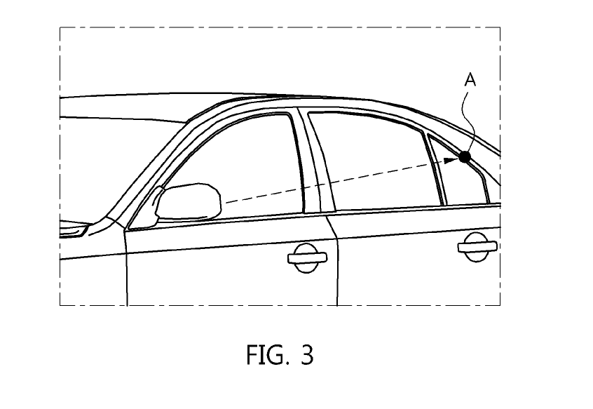

The side-view minors in which the first and second sensor units 100 and 200 are disposed are described in detail below with reference to FIG. 2.

FIG. 2 is a diagram illustrating each of the sensor units 100 and 200 disposed in each of the side-view mirrors according to an embodiment of the present invention.

Referring to FIG. 2, the first and second sensor units 100 and 200 may be installed in such a way as to be attached within the respective side-view mirrors or to the backs of glass parts of the side-view mirrors. The first and second sensor units 100 and 200 may be freely attached or detached. Furthermore, the first and second sensor units 100 and 200 are protected by packaging capable of specially shielding the first and second sensor units 100 against changes in temperature, humidity, and frequent impacts. Each of the first and second sensor units 100 and 200 includes a central processing unit (CPU), a radio frequency (RF), various sensors, and a battery module.

Each of the first and second sensor units 100 and 200 is equipped with at least one sensor. For example, each of the first and second sensor units 100 and 200 may be equipped with an acceleration sensor configured to measure sudden movement and a laser sensor configured to measure distance. In this case, the acceleration sensor performs measurement for primary determination, and the laser sensor performs additional measurement for additional determination in order to improve the accuracy of the determination.

The control unit 300 may compare the first measured value of the acceleration sensor included in the first sensor unit 100 with the second measured value of the acceleration sensor included in the second sensor unit 200 and then detect intrusion into the vehicle based on the results of the comparison.

Furthermore, the laser sensor may set the distance to any one reference point, for example, a specific point A shown in FIG. 3, inside or outside the vehicle as a reference distance, and may monitor the front and back doors of the vehicle based on the reference distance.

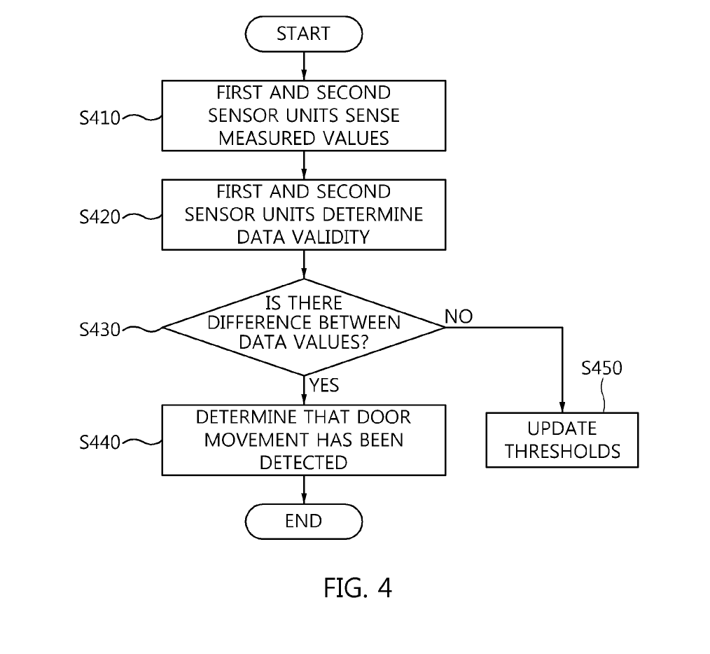

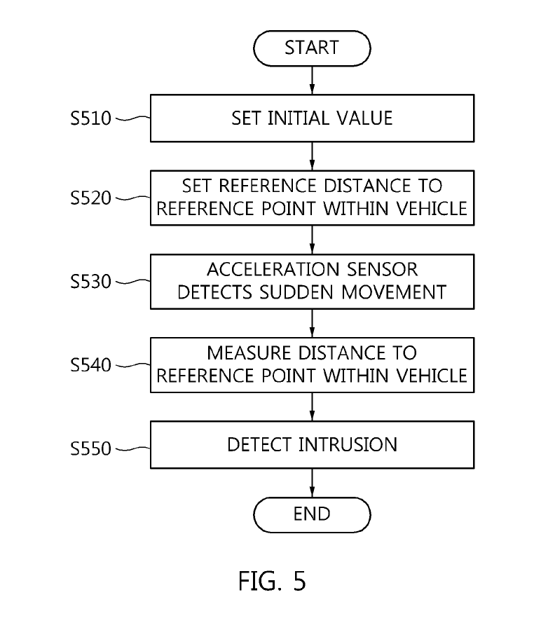

A method of detecting intrusion into a vehicle is described in detail below with reference to FIGS. 4 and 5.

FIG. 4 is a flowchart illustrating a method of detecting intrusion into a vehicle according to an embodiment of the present invention.

First, the apparatus for detecting intrusion into a vehicle includes the first sensor unit 100 disposed in the left side-view minor, the second sensor unit 200 disposed in the right side-view minor, and the control unit 300 configured to issue commands to the ECU 400 within the vehicle based on the sensing results of the first and second sensor units 100 and 200.

Referring to FIG. 4, the apparatus for detecting intrusion into a vehicle senses a first measured value via an acceleration sensor included in the first sensor unit 100 and a second measured value via an acceleration sensor included in the second sensor unit 200 at step S410.

The first and second sensor units 100 and 200 perform the data validity of the first and second measured values at step S420. More specifically, the first sensor unit 100 compares the first measured value with a preset first threshold, and then determines data validity based on the results of the comparison. Furthermore, the second sensor unit 200 compares the second measured value with a preset second threshold, and then determines data validity based on the results of the comparison. If the measured value is larger than the threshold, the sensor unit determines that the measured value is valid.

The apparatus for detecting intrusion into a vehicle checks whether or not there is the difference between the first and second measured values at step S430.

If there is the difference between the first and second measured values, the apparatus for detecting intrusion into a vehicle determines that a door in which a sensor unit having a higher measured value is disposed has been opened at step S440.

If there is no difference between the first and second measured values, the apparatus for detecting intrusion into a vehicle sets the measured values as new thresholds and updates the first and second thresholds with the new thresholds at step S450.

FIG. 5 is a flowchart illustrating a method of detecting intrusion into a vehicle according to another embodiment of the present invention.

First, the apparatus for detecting intrusion into a vehicle detects intrusion into a vehicle when the operation mode of the vehicle is an intrusion monitoring mode.

Referring to FIG. 5, the apparatus for detecting intrusion into a vehicle sets the initial values of an acceleration sensor and a laser sensor included in the respective first and second sensor units 100 and 200 at step S510.

The apparatus for detecting intrusion into a vehicle sets the distance to a reference point inside or outside the vehicle, for example, the specific point A of the back door of the vehicle, as shown in FIG. 3, as a reference distance at step S520. If the distance to the specific point A of the back door of the vehicle is set as the reference distance as described above, the movement of the back door of the vehicle may be monitored based on the set reference distance.

The apparatus for detecting intrusion into a vehicle detects the sudden movement of the vehicle based on the results of the comparison between the initial value and first measured value of the acceleration sensor of the first sensor unit 100 and the results of the comparison between the initial value and second measured value of the acceleration sensor of the second sensor unit 200 at step S530.

More specifically, the apparatus for detecting intrusion into a vehicle senses the first measured value of the acceleration sensor included in the first sensor unit 100 and the second measured value of the acceleration sensor included in the second sensor unit 200, and determines the data validity of the first and second measured values. Thereafter, the apparatus for detecting intrusion into a vehicle checks whether or not there is the difference between the first and second measured values and detects the sudden movement of the vehicle based on the results of the checking.

The apparatus for detecting intrusion into a vehicle according to an embodiment of the present invention sets the laser sensor to a standby state until the sudden movement of the vehicle is detected by the acceleration sensor, thereby maintaining low power.

The apparatus for detecting intrusion into a vehicle measures the current distance to the reference point inside or outside the vehicle using the laser sensor of the first sensor unit 100 or the second sensor unit 200 at step S540.

For example, if the sudden movement of one of the doors of the vehicle is detected by the acceleration sensor, distance measurement is performed using the laser sensor. If the front or back door of the vehicle has been opened, the opening of the door is detected because the distance between the reference point and the laser sensor is changed. Furthermore, if an intruder enters a vehicle through a window of the vehicle, a measured current distance is different from the reference distance because a human's body obstructs a laser path and thus intrusion may be detected based on the difference.

The apparatus for detecting intrusion into a vehicle compares the current distance measured at step S540 with the reference distance set at step S520 and detects intrusion based on the results of the comparison at step S550.

As described above, the apparatus and method for detecting intrusion into a vehicle set the laser sensors to a standby state until the sudden movement of a vehicle is detected by the acceleration sensors, thereby providing a vehicle intrusion detection technology having high sensitivity and low error rate through complex sensing based on low-power design. As described above, in a vehicle intrusion detection technology, accurate detection and the precise verification of detection are important. If intrusion is detected using the intrusion detection apparatus installed outside a vehicle as in the present invention, a rapid alarm can provided and measures can be rapidly taken compared to an internal detection device.

Furthermore, the present invention is advantageous in that the wireless sensor nodes are employed, so that sensors can be used in various manners, the association with internal sensors can be achieved, and the manufacturing cost can be reduced through mass production. Accordingly, the advantage of reducing the load of replacing broken parts can be also achieved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of detecting intrusion into a vehicle, comprising:
setting an initial value of at least one sensor included in each of first and second sensor units disposed in respective side-view mirrors on both sides of a vehicle;
setting a distance between each of the side-view mirrors and a reference point of the vehicle as a reference distance;
detecting a sudden movement of the vehicle based on results of comparison between measured and initial values of an acceleration sensor included in each of the first and second sensor units; and
measuring a current distance to the reference point using a laser sensor included in the first or second sensor unit when the sudden movement is detected, and detecting intrusion into the vehicle by comparing the current distance with the reference distance.

2. The method of claim 1, further comprising, before detecting the intrusion into the vehicle, setting the laser sensor to a standby state if the sudden movement of the vehicle is not detected.

3. The method of claim 1, wherein detecting the sudden movement of the vehicle comprises:
determining data validity by comparing a first measured value sensed by a first acceleration sensor of the first sensor unit with a threshold corresponding to the first acceleration sensor;
determining data validity by comparing a second measured value sensed by a second acceleration sensor of the second sensor unit with a threshold corresponding to the second acceleration sensor;
checking whether or not there is a difference between the first and second measured values; and
determining that a door including a side-view mirror in which a sensor unit having a higher measured value is disposed has been moved if there is a difference between the first and second measured values.

4. The method of claim 3, wherein determining the data validity comprises determining that the first measured value is valid if the first measured value is higher than a threshold corresponding to the first acceleration sensor, and determining that the second measured value is valid if the second measured value is higher than a threshold corresponding to the second acceleration sensor.

5. The method of claim 3, wherein checking whether or not there is the difference comprises updating the first measured value with a new threshold if there is no difference between the first and second measured values.

6. An apparatus for detecting intrusion into a vehicle, comprising:
a first sensor unit disposed in a left side-view mirror of a vehicle, and configured to include an acceleration sensor and a laser sensor;
a second sensor unit disposed in a right side-view mirror of the vehicle, and configured to include an acceleration sensor and a laser sensor; and
a control unit configured to detect a sudden movement of the vehicle based on results of comparison between measured and initial values of the acceleration sensor included in each of the first and second sensor units, and to detect intrusion into the vehicle using the laser sensor of the first or second sensor unit.

7. The apparatus of claim 6, wherein the control unit is configured to:
set a distance between each of the side-view mirrors and a reference point of the vehicle as a reference distance before detecting the intrusion into the vehicle;
measure a current distance between each of the side-view mirror and the reference point using the laser sensor when the sudden movement of the vehicle is detected; and
detect intrusion into the vehicle by comparing the measured current distance with the reference distance.

8. The apparatus of claim 6, wherein the control unit is configured to, before detecting intrusion into the vehicle, set the laser sensor to a standby state if the sudden movement of the vehicle is not detected.

9. The apparatus of claim 6, wherein the first sensor unit is configured to determine data validity by comparing a first measured value sensed by a first acceleration sensor of the first sensor unit with a threshold corresponding to the first acceleration sensor, and to determine that the first measured value is valid if the first measured value is higher than the threshold corresponding to the first acceleration sensor.

10. The apparatus of claim 6, wherein the second sensor unit is configured to determine data validity by comparing a second measured value sensed by a second acceleration sensor of the second sensor unit with a threshold corresponding to the second acceleration sensor, and to determine that the second measured value is valid if the second measured value is higher than the threshold corresponding to the second acceleration sensor.

11. The apparatus of claim 6, wherein the control unit is configured to determine that a door including a side-view mirror in which a sensor unit having a higher measured value is disposed has been moved if there is a difference between a first measured value sensed by a first acceleration sensor of the first sensor unit and a second measured value sensed by a second acceleration sensor of the second sensor unit.
